(19) United States
(12) Patent Application Publication
(10) Pub. No.: US 2024/0393052 A1
(43) Pub. Date: Nov. 28, 2024

(54) HEAT TREATMENT APPARATUS, METHOD OF MAINTAINING HEAT TREATMENT APPARATUS, AND METHOD OF REGENERATING LAMP SLEEVE

(71) Applicant: GLOBALWAFERS JAPAN CO., LTD., Kitakanbara-gun (JP)

(72) Inventors: Haruo SUDO, Kitakanbara-gun (JP); Tatsuhiko AOKI, Kitakanbara-gun (JP); Manabu KATO, Kitakanbara-gun (JP)

(73) Assignee: GLOBALWAFERS JAPAN CO., LTD., Kitakanbara-gun (JP)

(21) Appl. No.: 18/672,730

(22) Filed: May 23, 2024

(30) Foreign Application Priority Data
May 25, 2023 (JP) 2023-086285

(51) Int. Cl. F27D 21/00; F27D 11/00; F27D 19/00; F27D 21/04; F27D 25/00

(52) U.S. Cl. CPC F27D 21/0014; F27D 11/00; F27D 21/04; F27D 25/008; F27D 2019/0003

(57) ABSTRACT

The timing for removing granular SiOx deposits on an inner wall of a lamp sleeve is easily obtained to prevent a decrease in production efficiency and suppress an increase in power consumption for heat treatment. A heat treatment apparatus includes a plurality of lamps that heats a semiconductor substrate, a lamp sleeve that reflects irradiation light of the plurality of lamps; a power supply that applies a lamp voltage to the plurality of lamps; a temperature detector that detects a temperature of the semiconductor substrate, a controller that controls the lamp voltage or lamp current applied to the plurality of lamps, and a warning unit that makes a warning on timing for cleaning the lamp sleeve through a display or a voice. The controller causes the warning unit to issue a warning when the lamp voltage or lamp current applied to the plurality of lamps exceeds a predetermined threshold.

### TECHNICAL FIELD

The present invention relates to a heat treatment apparatus, a method for maintaining the heat treatment apparatus, and a method for regenerating a lamp sleeve, and more particularly, to a heat treatment apparatus for heat-treating a semiconductor substrate with the thermal energy of a lamp, a method for maintaining the heat treatment apparatus, and a method for regenerating a lamp sleeve.

### BACKGROUND ART

For example, a silicon wafer used for a substrate of a semiconductor device is required to form a defect-free layer in which a void defect called a crystal originated particle (COP) does not exist on the surface and in the surface layer to be the active regions of the semiconductor device. As a technique in response to such a requirement, the technique of performing rapid thermal processing (RTP) is known.

In a heat treatment apparatus that performs RTP, hereinafter referred to as an RTP apparatus, to rapidly raise the temperature of a silicon wafer to a temperature exceeding 1200° C., the apparatus configuration is designed to efficiently absorb light, hereinafter also referred to as “irradiation light”, emitted from a lamp as a heat source into the silicon wafer to minimize energy loss.

For example, Patent Literature 1 (JA-A-2017-11282) proposes a lamp sleeve that contains silver in the reflective film that covers the lamp surroundings for the purpose of increasing the reflectivity of the irradiated light from the heating lamp (increasing energy efficiency to the substrate to be treated).

### CITATION LIST

### Patent Literature

PTL 1: JA-A-2017-11282

### SUMMARY OF INVENTION

### Technical Problem

Meanwhile, there has been a phenomenon that when heat treatment is repeatedly performed in the RTP apparatus, it is necessary to gradually increase the voltage applied to the lamp, hereinafter referred to as “lamp voltage”, in order to set the temperature in a chamber at a predetermined temperature of 1200° C. or higher. This has resulted in a gradual increase in power consumption for RTP, or heat treatment, which has been problematic.

The difficulty in raising the temperature of the silicon wafer is believed to be because the irradiation light from the lamp gradually becomes more difficult to reach the silicon wafer as the number of operations increases, resulting in greater energy loss.

To solve such a problem, the inventor of the present application has conducted intensive studies to continuously operate the RTP apparatus with the maximum attainable temperature of the silicon wafer exceeding 1200° C. and to identify the cause of changes in the output from the lamp over time. As a result, it was found that the main cause is that the inner wall of the lamp sleeve, which is arranged to surround the heating lamp, becomes fogged to reduce the reflectivity.

Furthermore, after investigating the cause of this fogging, it was found that the fogging was due to the deposition of granular SiOx, and the SiOx was generated by the sublimation of glass, or lamp glass, used in a lamp envelope caused by being heated by the heat of the filament.

The present invention has been made under such circumstances, and an object of the present invention is to easily obtain the timing when the granular SiOx deposited on an inner wall of a lamp sleeve is to be removed, to prevent a decrease in production efficiency, and to suppress an increase in power consumption for heat treatment.

A heat treatment apparatus according to the present invention made to solve the above problems includes a plurality of lamps that heats a semiconductor substrate, a lamp sleeve that is detachably arranged to surround each of the plurality of lamps and reflects irradiation light of the plurality of lamps, a power supply that applies a lamp voltage to the plurality of lamps, a temperature detector that detects a temperature of the semiconductor substrate; a controller that controls a lamp voltage or a lamp current applied to the plurality of lamps, and a warning unit that gives a warning about timing for cleaning the lamp sleeve through a display or a voice. The controller controls the lamp voltage or the lamp current applied to the plurality of lamps based on the temperature of the semiconductor substrate detected by the temperature detector and causes the warning unit to issue a warning when the lamp voltage or the lamp current applied to the plurality of lamps exceeds a predetermined threshold.

Desirably, the controller stops applying the lamp voltage or the lamp current to the plurality of lamps when the lamp voltage or the lamp current applied to the lamps exceeds a predetermined threshold and allows the controller to apply the lamp voltage or the lamp current to the corresponding lamp when the lamp sleeve of the corresponding lamp is removed and the lamp sleeve is reattached.

With such a configuration, it is possible to easily obtain the timing when the granular SiOx deposited on the inner wall of the lamp sleeve is to be removed, and removing the fogging due to the deposition of SiOx in accordance with this timing can prevent a reduction in production efficiency without the occurrence of unnecessary chamber maintenance time.

In addition, by eliminating the fogging caused by the deposition of SiOx adhering to the lamp sleeve, it is possible to restore the reflectivity of the irradiation light in the lamp sleeve and effectively heat the semiconductor substrate to a desired temperature without increasing the lamp output, thus preventing an increase in power consumption due to the heat treatment.

A method of maintaining a heat treatment apparatus according to the present invention, which is made to solve the above problems, includes a step of heating a semiconductor substrate using the plurality of lamps by controlling a lamp voltage or a lamp current applied to the plurality of lamps by the controller, a step of controlling the lamp voltage applied to the plurality of lamps based on the temperature of the semiconductor substrate which is detected by the temperature detector, and a step of giving a warning through a display or a voice by the warning unit of the timing for cleaning the lamp sleeve which is arranged to surround each of the plurality of lamps and reflects the irradiation light of the plurality of lamps when the lamp voltage or the lamp current applied to the plurality of lamps exceeds a predetermined threshold.

Preferably, the method further includes, after the step of causing the warning unit to issue a warning through a display or a voice, a step of removing a lamp sleeve of the corresponding lamp and cleaning the lamp sleeve using an acidic aqueous solution and a step of attaching the cleaned lamp sleeve.

According to such a method, it is possible to easily obtain the timing when to remove the granular SiOx deposited on the inner wall of the lamp sleeve, and removing the fogging due to the deposition of SiOx in accordance with this timing can prevent a reduction in production efficiency without incurring unnecessary chamber maintenance time.

In addition, removing the fogging due to the deposition of SiOx adhering to the lamp sleeve makes it possible to restore the reflectance of the irradiation light in the lamp sleeve and to effectively heat the semiconductor substrate to a desired temperature without increasing the lamp output, thereby preventing an increase in power consumption for heat treatment.

A method for regenerating a lamp sleeve according to the present invention, which has been made to solve the above problems, is a method for regenerating a lamp sleeve using the method for maintaining the heat treatment apparatus and includes a step of cleaning the lamp sleeve using an acidic aqueous solution, after the step of causing the warning unit by the controller to issue a warning about the timing for cleaning a lamp sleeve reflecting the irradiation light of the plurality of lamps by a display or a voice.

Preferably, in the step of cleaning the lamp sleeve using an acidic aqueous solution, the lamp sleeve is cleaned by immersing the lamp sleeve in aqueous hydrogen fluoride (HF) solution having a concentration of 1% or more and 5% or less for 1 minute or more and 100 minutes or less.

This method allows easy removal of the granular SiOx deposited on the inner wall of the lamp sleeve.

### Advantageous Effects of Invention

According to the present invention, it is possible to easily obtain the timing when to remove the granular SiOx deposited on the inner wall of the lamp sleeve, to prevent a decrease in production efficiency, and to suppress an increase in power consumption for heat treatment.

### BRIEF DESCRIPTION OF DRAWINGS

FIG. 1 is a cross-sectional view schematically illustrating an RTP apparatus (heat treatment apparatus) according to an embodiment of the present invention;

FIG. 2 is an enlarged cross-sectional view of a halogen lamp provided in the RTP apparatus of FIG. 1;

FIG. 3 is a flowchart of the procedure of the control method for the present invention;

FIG. 4 is a micrograph showing the result of Experiment 1 of the example; and

FIG. 5 is a graph illustrating the results of Experiment 3 of the example.

### DESCRIPTION OF EMBODIMENTS

Embodiments of the present invention will be described in detail below with reference to the drawings.

The embodiments of the present invention will be described, as an example of an RTP apparatus or a heat treatment apparatus, in which a lamp that is a heat source, such as a high-voltage tungsten halogen lamp, is disposed in a lamp sleeve.

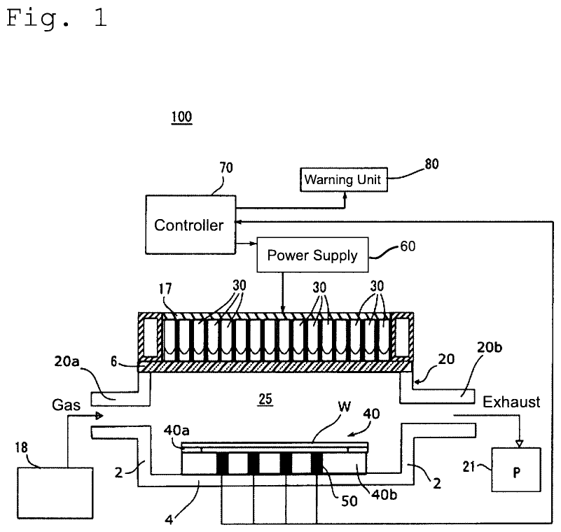

FIG. 1 is a cross-sectional view schematically illustrating an RTP apparatus 100, or a heat treatment apparatus, according to an embodiment of the present invention. The RTP apparatus 100 includes a processing chamber 20, and the processing chamber 20 includes a chamber side wall 2, a chamber bottom 4 connected to the chamber side wall 2, and a quartz window 6 disposed above the chamber side wall 2.

The chamber side wall 2, the chamber bottom 4, and the quartz window 6 constituting the processing chamber 20 form a chamber 25 for heat treating the silicon wafer W as a semiconductor substrate therein. The RTP apparatus 100 is provided with a slit valve door, not shown, which penetrates through the chamber side wall 2 to transfer the silicon wafer W into the chamber 25.

In the present embodiment, the silicon wafer W will be described as an example of the semiconductor substrate, but is not limited to the silicon wafer W and may be such as a SiC wafer, a GaN wafer, or a wafer on which a circuit pattern is formed.

The RTP apparatus 100 is provided with a gas introduction port 20a formed in the chamber side wall 2, and the gas introduction port 20a is connected to a gas supply source 18 configured to supply one or more processing gases to the chamber 25. The RTP apparatus 100 is provided with a gas exhaust port 20b formed in the chamber side wall 2, and the gas exhaust port 20b is connected to a vacuum pump 21 to exhaust gas from the chamber 25 to the outside.

Further, the RTP apparatus 100 includes a substrate support 40 in the chamber 25 in the processing chamber 20, which supports the silicon wafer W. Further, although not shown, a rotating means is provided for rotating the silicon wafer W around its central axis at a predetermined speed.

The substrate support 40 includes an annular susceptor 40a supporting the periphery of the silicon wafer W, and a stage 40b supporting the susceptor 40a.

The temperature of the silicon wafer W in the RTP apparatus 100 is controlled by a plurality of radiation thermometers 50, or temperature detectors, embedded in the stage 40b of the substrate support 40. The radiation thermometers 50 are connected to a controller 70 which is a computer, and the controller 70 controls the temperature of the silicon wafer W based on the temperature information of the silicon wafer W detected by the radiation thermometers 50.

That is, the controller 70 measures the temperatures at multiple points, for example, nine points, in the substrate plane in the substrate radial direction at the bottom of the silicon wafer W with the radiation thermometers 50. Based on the measured temperatures, the controller 70 performs control of a plurality of halogen lamps 30, such as individual ON-OFF control of each lamp, increase/decrease control of supplied power, and control of the light emission intensity of light to be emitted.

The plurality of halogen lamps 30 is disposed above the quartz window 6 and are configured to transmit thermal energy through the quartz window 6 toward the silicon wafer W. The plurality of halogen lamps 30 are arranged in, for example, a hexagonal pattern in plan view. Each of the plurality of halogen lamps 30 is connected to the heating assembly base 17 for electrical connection to the power supply 60.

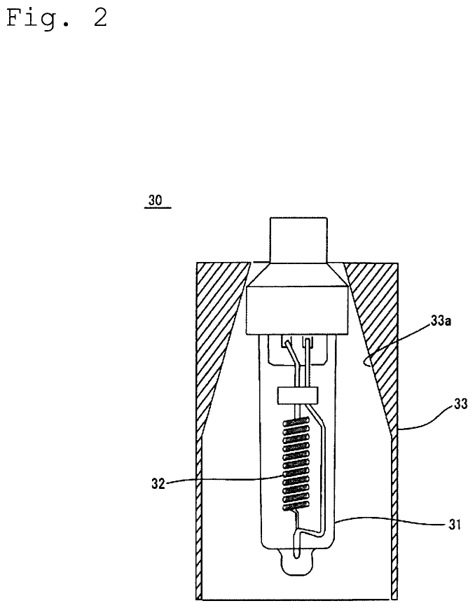

Each halogen lamp 30 is configured as shown in FIG. 2, for example. In the halogen lamp 30 shown in FIG. 2, a tungsten filament coil 32 is disposed in a lamp glass 31 formed of quartz glass, and a gas containing a halogen gas is sealed in the lamp glass 31.

The lamp glass 31 is surrounded by a tubular lamp sleeve 33, and an inner wall 33a of the lamp sleeve 33 is inclined so that thermal energy emitted through the lamp glass 31 is directed to the silicon wafer W below. The inner wall 33a of the lamp sleeve 33 is preferably plated with gold (Au). This is because the gold (Au) plating has high heat resistance, high reflectivity, and high acid resistance.

The lamp sleeve 33 is configured to be detachable from the RTP apparatus 100, and only the lamp sleeve 33 is configured to be easily detachable. As to be described in detail later, this configuration allows the lamp sleeve 33 to be easily cleaned and the lamp sleeve 33 to be regenerated and then reattached to the RTP apparatus 100.

A lamp voltage is applied to each halogen lamp 30 from the power supply 60. The value of the lamp voltage is controlled by the controller 70. It should be noted that the controller 70 may control the current applied to the halogen lamp 30 (hereinafter also referred to as the “lamp current”) instead of the lamp voltage.

Further, the RTP apparatus 100 according to the present embodiment includes a warning unit 80 for providing notification of the degree of contamination on the inner wall 33a of the lamp sleeve 33, for example, through a screen display or a warning sound, or a voice, to encourage the cleaning of the inner wall 33a of the lamp sleeve 33.

Specifically, the controller 70 issues a warning through the warning unit 80 when a lamp voltage, or a lamp current, applied to the halogen lamp 30 required to set the temperature of the silicon wafer W to a predetermined temperature, such as 1300° C., exceeds a predetermined threshold.

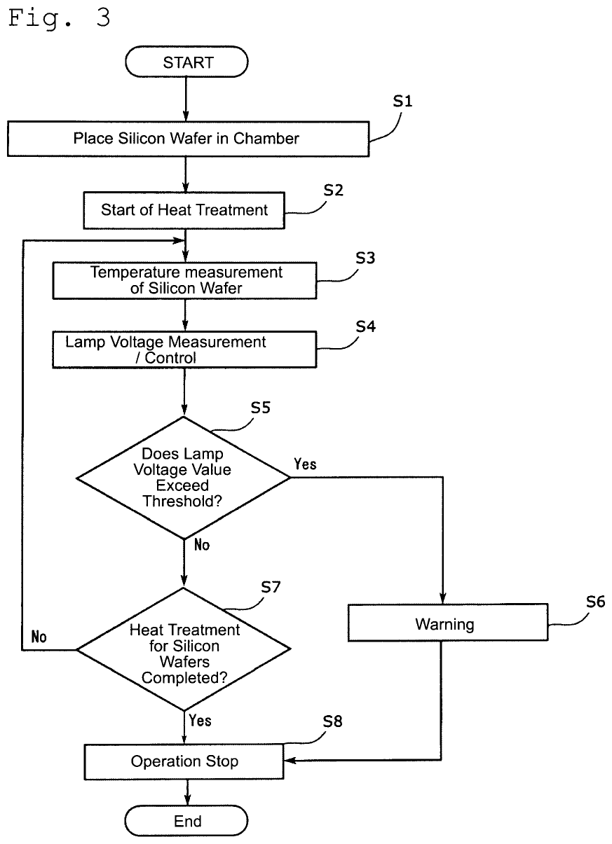

Subsequently, a series of operations of the heat treatment apparatus (RTP apparatus) according to the present invention will be described based on the flow chart of FIG. 3.

First, in the RTP apparatus 100 shown in FIG. 1, the silicon wafer W is placed in the processing chamber 20, which is maintained at a desired initial temperature (Step S1 of FIG. 3).

Then, in a case where the silicon wafer W is heat-treated at a target temperature of, for example, 1300° C., the controller 70 determines a lamp voltage, or an initial setting voltage, applied to the halogen lamp 30 corresponding thereto, and applies the lamp voltage to each halogen lamp 30 by the power supply 60. Each halogen lamp 30 irradiates the silicon wafer W with light corresponding to the applied lamp voltage. As a result, the silicon wafer W is started to be heated. (Step S2 of FIG. 3)

In each halogen lamp 30, the surface of the lamp glass 31 in which the filament coil 32 is disposed is sublimated to granular SiOx by the heat of the filament coil 32 and adhered to the inner wall 33a of the lamp sleeve 33. Thus, when the RTP apparatus 100 is continuously operated and the heat treatment is repeated, granular SiOx is deposited on the inner wall 33a of the lamp sleeve 33 to cause fogging, thereby reducing the heat-reflecting function of the lamp sleeve 33. Note that SiOx is significantly deposited on the inner wall of the lamp sleeve in heat treatment at 1250° C. or higher, and therefore, it is particularly preferable to apply the present embodiment to an RTP apparatus which performs the heat treatment at a maximum temperature reached of 1250° C. or higher.

During the heating of the silicon wafer W, the temperatures at the multiple points such as nine points in the substrate plane in the substrate radial direction at the bottom of the silicon wafer W are measured by the radiation thermometers 50. (Step S3 of FIG. 3)

Based on the temperatures measured in Step S3, the controller 70 measures the applied voltage or current to the halogen lamp 30 in Step S4 of FIG. 3, and controls the applied voltage or current so that the silicon wafer W has a desired temperature.

Here, when the applied voltage or current to the halogen lamp 30 exceeds a predetermined threshold value (Step S5 of FIG. 3), the controller 70 issues the warning by the warning unit 80 by means of a display on the screen or the like or a voice that the lamp sleeve 33 needs to be cleaned (Step S6 of FIG. 3). The controller 70 stops applying the lamp voltage to the halogen lamp 30 and stops the operation of the RTP apparatus 100 (Step S8 of FIG. 3).

When the warning is issued by the warning unit 80, the cleaning operation of the lamp sleeve 33 may be performed after the operation of the RTP apparatus 100 is stopped. That is, the lamp sleeve 33 is removed and cleaned using an acidic aqueous solution, for example, immersed in an aqueous HF solution having a concentration of 1% or more and 5% or less for 1 min or more and 100 min or less, and then the cleaned lamp sleeve 33 is mounted. As a result, the controller 70 allows the lamp voltage to be applied to the halogen lamp 30 and resumes the operation of the RTP apparatus 100. In a case where the aqueous HF solution is used as the acidic aqueous solution, cleaning may take time if the concentration is less than 1%. If the concentration exceeds 5%, the nickel body of the Au-plated lamp sleeve 33 may be damaged. For this reason, the concentration of the aqueous HF solution is preferably 1% or more and 5% or less.

Meanwhile, in the step S5 of FIG. 3, if the applied voltage or applied current to the halogen lamp 30 does not exceed the predetermined threshold, the heat treatment for the silicon wafer W is performed until the heat treatment is completed (S7 of FIG. 3).

As described above, according to the embodiment of the present invention, it is possible to easily obtain the timing when to remove the granular SiOx deposited on the inner wall 33a of the lamp sleeve 33 and by removing the fogging due to the deposition of SiOx in accordance with this timing, to prevent a reduction in production efficiency without incurring unnecessary chamber maintenance time.

In addition, by removing the fogging caused by the deposition of SiOx adhering to the inner wall 33a of the lamp sleeve 33, it is possible to restore the reflectivity of the irradiation light in the lamp sleeve 33 and to effectively heat the semiconductor substrate to a desired temperature without increasing the lamp output, thereby preventing an increase in the power consumption for heat treatment.

In the above embodiment, the magnitude of the voltage supplied to the halogen lamp 30 was monitored by the controller 70, but the present invention is not limited thereto. The magnitude of the current supplied to the halogen lamp 30 may be monitored, and the warning may be controlled in response to whether or not the current exceeds a predetermined threshold.

In the above embodiment, an example has been described in which the lamp voltages applied to the plurality of halogen lamps 30 are uniformly controlled, but the present invention is not limited thereto.

For example, the temperatures in separate regions of each silicon wafer W, to which the respective halogen lamps 30 correspond, may be measured. Then, the voltages applied to the respective halogen lamps 30 may be controlled and monitored based on the temperatures in the respective regions.

More specifically, the silicon wafer W may be divided into a plurality of concentric regions, which are regions 1, 2, . . . , n, each having a predetermined width in the radial direction from the center of the silicon wafer W. The applied voltages to the respective halogen lamps 30 may be controlled based on the temperatures in the respective regions.

### EXAMPLES

Hereinafter, the present invention will be described more specifically with reference to Examples, but the present invention is not to be interpreted as limited by the following examples.

### Experiment 1

In Experiment 1, it is verified whether or not the inner wall of the lamp sleeve in the halogen lamp became fogged by continuously operating the RTP apparatus.

The RTP apparatus has been operated continuously for 100,000 cycles of a heat treatment process at a heating temperature of 1, 300° C. for silicon wafers for semiconductor devices.

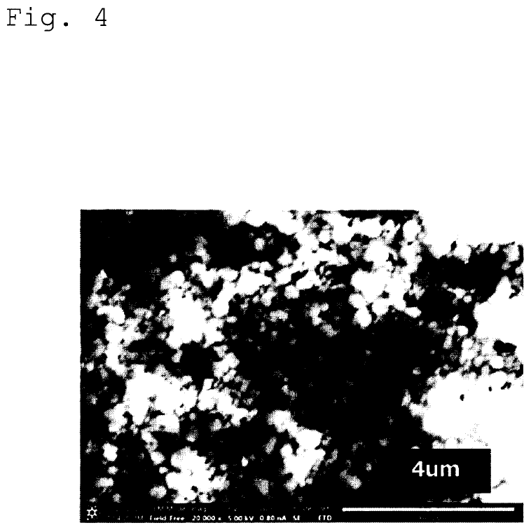

The inner wall of the lamp sleeve, used continuously for 100,000 cycles, was observed by a scanning electron microscope integrated with an energy dispersive X-ray spectroscope (SEM/EDX). FIG. 4 shows a microphotograph of the result of this observation.

The SEM observation result showed that the inner wall of the sleeve was fogged in black and granular deposits were confirmed. EDX analysis revealed that the granular deposits were SiOx undetectable in a new lamp sleeve, consisting of silicon (Si) and oxygen (O).

### Experiment 2

In Experiment 2, a preferred concentration of an aqueous HF solution was verified for cleaning a lamp sleeve with SiOx deposited with the aqueous HF solution.

In Example 1, the continuously used lamp sleeve used in Experiment 1 was cleaned with a 5% aqueous HF solution for 1 min. As a result, the SiOx was dissolved by the HF, and the fogging was eliminated. It is found that the inner wall of this cleaned, regenerated sleeve was observed by SEM/EDX, and the result showed that the SiOx was not completely but significantly removed.

In Example 2, the continuously used lamp sleeve used in Experiment 1 was cleaned with a 1% aqueous HF solution, and observed until SiOx was dissolved by HF and the fogging disappeared. The results show that it took 100 min for SiOx to dissolve in HF and for the fogging to disappear. The cleaning time was determined to be the maximum value in a practical range.

In Comparative Example 1, the continuously used lamp sleeve used in Experiment 1 was cleaned with a 0.9% aqueous HF solution, and observed until SiOx was dissolved by HF and the fogging disappeared. As a result, it took more than 100 min for SiOx to be dissolved in HF and for the fogging to disappear. That is, it is confirmed that an HF solution with a concentration of 1% or higher is preferable because using an HF solution with a concentration of less than 1% results in an excessively long cleaning time.

In Comparative Example 2, the continuously used lamp sleeve used in Experiment 1 was cleaned with a 6% aqueous HF solution for 1 min. As a result, although SiOx was dissolved by HF and the fogging disappeared, there was a possibility that the Au plating covering the lamp sleeve may peel off and the nickel body of the lamp sleeve may be damaged.

Thus, it is confirmed that the concentration of the aqueous HF solution is preferably 1% or more and 5% or less, and the cleaning time (immersion time) is in the range of 1 minute or more and 100 minutes or less.

### Experiment 3

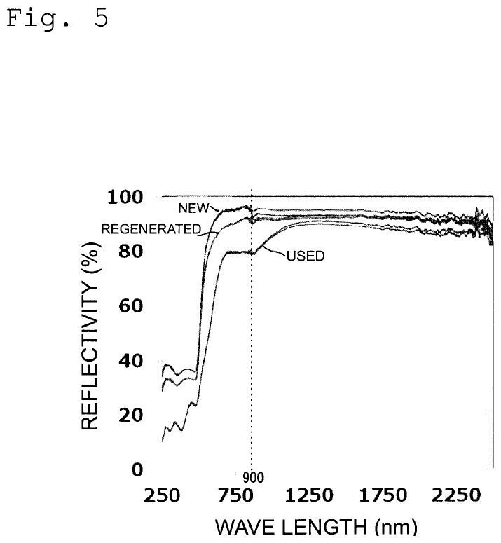

In Experiment 3, the reflectivity of light of each of the inner walls of the following lamp sleeves of the continuously used lamp sleeve obtained in Experiment 1, referred to as the used product, the lamp sleeve cleaned and regenerated in Experiment 2, referred to as the regenerated product, and a new lamp sleeve, referred to as the new product was measured using a SolidSpec-3700 DUV ultraviolet-visible-near-infrared spectrophotometer manufactured by Shimadzu Corporation. The graph of FIG. 5 shows the results. In the graph of FIG. 5, the vertical axis represents the reflectivity (%) and the horizontal axis represents the wavelength (nm).

As shown in the graph of FIG. 5, the reflectivity of the inner wall of the cleaned and regenerated lamp sleeve, referred to as the regenerated product, was restored by about 53% to 90% at wavelengths of 900 nm or more, which significantly affects the heating of silicon wafers, compared to the inner wall of the continuously used lamp sleeve, referred to as the used product. It is found that the inner wall of the cleaned and regenerated lamp sleeve was closer to that of the new product, although not completely.

### REFERENCE SIGNS LIST

20 processing chamber
20a gas introduction port
20b gas exhaust port
25 chamber
30 halogen lamp (lamp)
33 lamp sleeve
33a inner wall
40 substrate support
40a susceptor
50 radiation thermometer (temperature detector)
60 power supply
70 controller
80 warning unit
W silicon wafer (semiconductor substrate)

What is claimed is:

1. A heat treatment apparatus, comprising:
a plurality of lamps that heats a semiconductor substrate;
a lamp sleeve detachably disposed to surround each of the plurality of lamps and reflecting irradiation light of the plurality of lamps;
a power supply that applies a lamp voltage to the plurality of lamps;
a temperature detector that detects a temperature of the semiconductor substrate;
a controller that controls a lamp voltage or a lamp current applied to the plurality of lamps; and
a warning unit that issues a warning about a timing for cleaning the lamp sleeve through a display or a voice,
wherein the controller controls the lamp voltage or the lamp current applied to the plurality of lamps based on the temperature of the semiconductor substrate detected by the temperature detector, and causes the warning unit to issue a warning when the lamp voltage or the lamp current applied to the plurality of lamps exceeds a predetermined threshold.

2. The heat treatment apparatus according to claim 1, wherein
the controller stops applying the lamp voltage or the lamp current to the plurality of lamps when the lamp voltage or the lamp current applied to the plurality of lamps exceeds the predetermined threshold, and
a lamp sleeve of the corresponding lamp is removed and the lamp sleeve is reattached, allowing the controller to apply the lamp voltage or the lamp current to the corresponding lamp.

3. A method for maintaining the heat treatment apparatus according to claim 1, the method comprising:
by the controller,
a step of controlling a lamp voltage or a lamp current applied to the plurality of lamps and heating a semiconductor substrate using the plurality of lamps;
a step of detecting the temperature of the semiconductor substrate using the temperature detector and controlling the lamp voltage applied to the plurality of lamps based on the temperature of the semiconductor substrate; and
a step of issuing a warning by the warning unit of the timing for cleaning a lamp sleeve which is arranged to surround each of the plurality of lamps and reflects irradiation light of the plurality of lamps, by a display or a voice, when the lamp voltage or the lamp current applied to the plurality of lamps exceeds a predetermined threshold.

4. The method of maintaining the heat treatment apparatus according to claim 3, further comprising:
after the step of issuing a warning by the warning unit through the display or the voice,
a step of removing a lamp sleeve of the corresponding lamp and cleaning the lamp sleeve using an acidic aqueous solution; and
a step of reattaching the cleaned lamp sleeve.

5. A method of regenerating a lamp sleeve, using the method for maintaining the heat treatment apparatus according to claim 3, the method of regenerating a lamp sleeve comprising:
after the step of issuing a warning from the warning unit by the controller about the timing for cleaning a lamp sleeve reflecting the irradiation light of the plurality of lamps by a display or a voice,
a step of cleaning the lamp sleeve by using an acidic aqueous solution.

6. The method of regenerating a lamp sleeve according to claim 5, wherein in the step of cleaning the lamp sleeve by using an acidic aqueous solution, the lamp sleeve is cleaned by immersing the lamp sleeve in aqueous hydrogen fluoride (HF) solution having a concentration of 1% or more and 5% or less for 1 min or more and 100 min or less.
